(19) United States
(12) Patent Application Publication
(10) Pub. No.: US 2025/0192343 A1
(43) Pub. Date: Jun. 12, 2025

(54) BATTERY PACK VENTING SYSTEM WITH COMPARTMENTALIZED CELL STACK

(71) Applicant: Ford Global Technologies, LLC, Dearborn, MI (US)

(72) Inventors: Jason C. Marcath, Dearborn, MI (US); Mohammadreza Eftekhari, Novi, MI (US); Alex Revels, Canton, MI (US); Kanchana Perumalla, Troy, MI (US); Karen Siler, Commerce Twp., MI (US); Zachary O. Baker, Deraborn, MI (US)

(21) Appl. No.: 18/915,690

(22) Filed: Oct. 15, 2024

Related U.S. Application Data
(60) Provisional application No. 63/607,888, filed on Dec. 8, 2023.

(51) Int. Cl. H01M 50/342; H01M 10/6555; H01M 50/211; H01M 50/249; H01M 50/289; H01M 50/507

(52) U.S. Cl. CPC H01M 50/3425; H01M 10/6555; H01M 50/211; H01M 50/249; H01M 50/289; H01M 50/507; H01M 2200/20

(57) ABSTRACT

A battery pack venting system is disclosed, comprising a battery pack enclosure with an interior housing a cell stack consisting of multiple battery cells arranged along a stack axis and segregated into groups within compartments. An intermediate cover assembly encloses the groups within the compartments and includes compartment vents for each compartment. The compartments vent through the compartment vents to an area between the intermediate cover and the battery pack enclosure.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to communicating vent byproducts from battery cells through a battery pack and then to an area outside the battery pack.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack venting system, including: a battery pack enclosure providing an interior; a cell stack within the interior, the cell stack including a plurality of battery cells disposed along a cell stack axis, the plurality of battery cells segregated into a plurality of groups, each of the groups including at least two battery cells; a plurality of compartments within the interior, each of the groups within the plurality of groups housed within a respective one of the compartments within the plurality of compartments; and an intermediate cover assembly within the interior, the intermediate cover assembly spanning over the cell stack to enclose the groups within the compartments, the intermediate cover assembly including at least one compartment vent associated with each of the compartments, the compartments each configured to vent through the at least one compartment vent to an area of the interior that is between the intermediate cover and the battery pack enclosure.

In some aspects, the techniques described herein relate to a battery pack venting system, wherein the at least one compartment vent is at least one one-way compartment vent.

In some aspects, the techniques described herein relate to a battery pack venting system, wherein the compartments are each configured to vent exclusively through the at least one compartment vent.

In some aspects, the techniques described herein relate to a battery pack venting system, wherein the plurality of battery cells are a plurality of pouch-style battery cells.

In some aspects, the techniques described herein relate to a battery pack venting system, wherein each of the compartments is configured to vent exclusively through the at least one compartment vent associated with that compartment.

In some aspects, the techniques described herein relate to a battery pack venting system, wherein the intermediate cover assembly is vertically above the plurality of compartments.

In some aspects, the techniques described herein relate to a battery pack venting system, wherein the battery pack enclosure includes an enclosure cover and an enclosure tray, the area between the enclosure cover and the intermediate cover assembly.

In some aspects, the techniques described herein relate to a battery pack venting system, further including an enclosure vent that communicates vent byproducts from the interior of the battery pack enclosure.

In some aspects, the techniques described herein relate to a battery pack venting system, wherein opposing sides of the compartments are provided between a first thermal barrier and a second thermal barrier, wherein other opposing sides of the compartments are provided between a first busbar frame and a second busbar frame.

In some aspects, the techniques described herein relate to a battery pack venting system, wherein the first thermal barrier and the second thermal barrier are disposed within the cell stack along the cell stack axis.

In some aspects, the techniques described herein relate to a battery pack venting system, wherein the cell stack is disposed between the first busbar frame and the second busbar frame.

In some aspects, the techniques described herein relate to a battery pack venting system, wherein the plurality of battery cells each include at least one tab terminal that connects to a first busbar mounted to the first busbar frame, a second busbar mounted to a second busbar frame, or both.

In some aspects, the techniques described herein relate to a battery pack venting system, wherein the plurality of compartments are a plurality of sealed compartments.

In some aspects, the techniques described herein relate to a battery pack venting system, wherein the compartments open upward to an underside of the intermediate cover assembly.

In some aspects, the techniques described herein relate to a battery pack venting system, wherein the at least one compartment vent is configured to open in response to a pressure increase within the compartment associated with that at least one compartment vent.

In some aspects, the techniques described herein relate to a battery pack venting system, wherein the at least one compartment vent includes a foil tape covering an aperture in a sheet of material, the foil tape configured to at least partially separate from the sheet.

In some aspects, the techniques described herein relate to a battery pack venting system, wherein the compartments are each configured to vent vent-byproducts emitted from one or more of the battery cells within one of the groups through the at least one compartment vent to the area of the interior that is between the intermediate cover and the battery pack enclosure.

In some aspects, the techniques described herein relate to a battery pack venting system, wherein the cell stack is disposed on a thermal exchange device within the interior, the thermal exchange device provide a vertically lower side of the at least one compartment.

In some aspects, the techniques described herein relate to a battery pack venting system, including: a battery pack enclosure providing an interior; a thermal exchange device; a cell stack within the interior upon the thermal exchange device, the cell stack including a plurality of battery cells disposed along a cell stack axis, the plurality of battery cells segregated into a plurality of groups separated along the axis by a thermal barrier, each of the groups including at least two battery cells; a first busbar frame alongside a first side of the cell stack; a second busbar frame alongside an opposite, second side of the cell stack, the thermal barriers each interfacing directing with the first busbar frame and the second busbar frame such that each of the groups of battery is compartmentalized within one of a plurality of sealed compartments within the interior, the sealed compartments each opening vertically upward, wherein horizontal sides of the sealed compartments are each established by opposing thermal barriers, the first busbar frame, and the second busbar frame, wherein a vertically lower side of the sealed compartment is provided by the thermal exchange device; and an intermediate cover assembly within the interior, the intermediate cover assembly spanning over the cell stack to cover vertically upper sides of the scaled compartments and to enclose the groups within the sealed compartments, the intermediate cover assembly including at least one compartment vent associated with each of the compartments, the compartments each configured to vent through the at least one compartment vent to an area of the interior that is between the intermediate cover and the battery pack enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective view of the battery pack of FIG. 1.

FIG. 3 illustrates a perspective and partially expanded view of selected portions of the battery pack of FIG. 2.

FIG. 4 illustrates a perspective view of a battery cell from the battery pack of FIG. 2.

FIG. 5 illustrates a section view taken at line 5-5 in FIG. 2.

FIG. 6 illustrates a section view taken at line 6-6 in FIG. 2.

FIG. 7 illustrates a close-up view of an area of FIG. 6 during a venting event with vent byproducts released from two battery cells moving through a compartment vent of the battery pack.

### DETAILED DESCRIPTION

This disclosure details exemplary systems utilized to communicate vent byproducts emitted from battery cells. The systems involve placing groups of battery cells in respective compartments within an enclosure. If one or more of the battery cells in any of the groups begin to vent, the vent byproducts can move out of the associated compartment through a compartment vent that is within in an intermediate cover assembly. The vent byproducts move through the compartment vent to an area between the intermediate cover and a portion of the enclosure. From that area, the vent byproducts can be communicated through a battery pack vent to an area outside the battery pack enclosure. These and other features are discussed in greater detail in the following paragraphs.

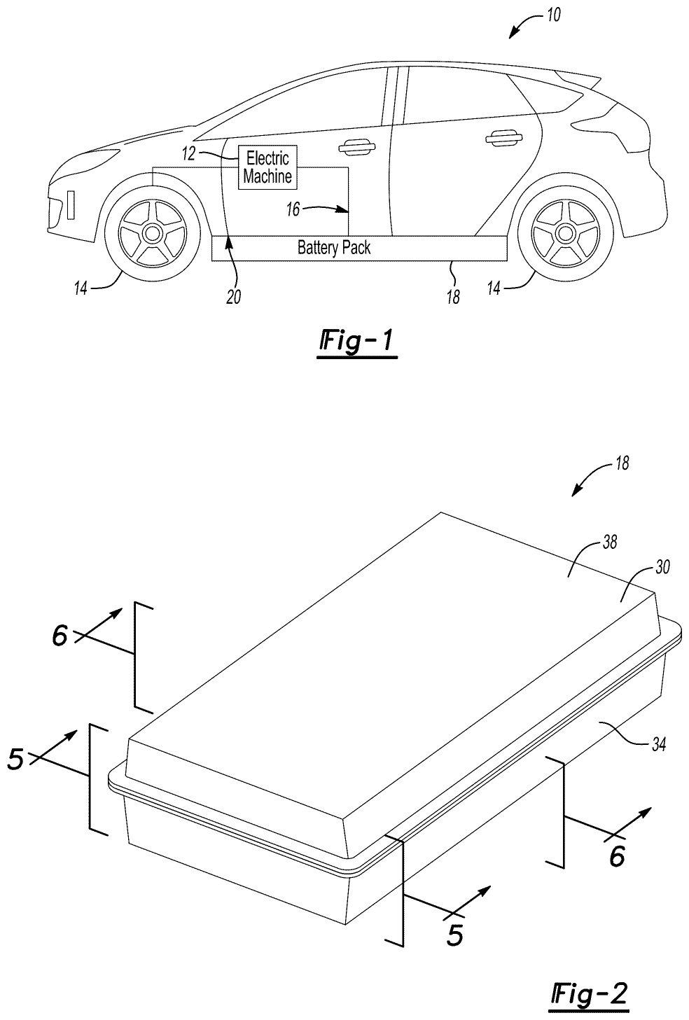

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

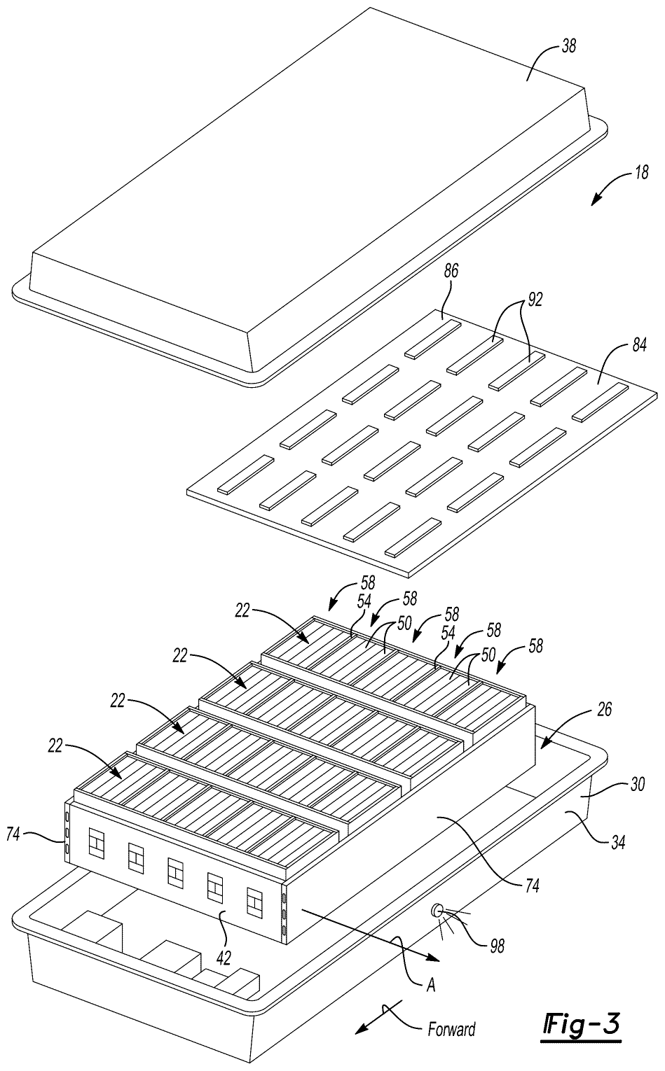

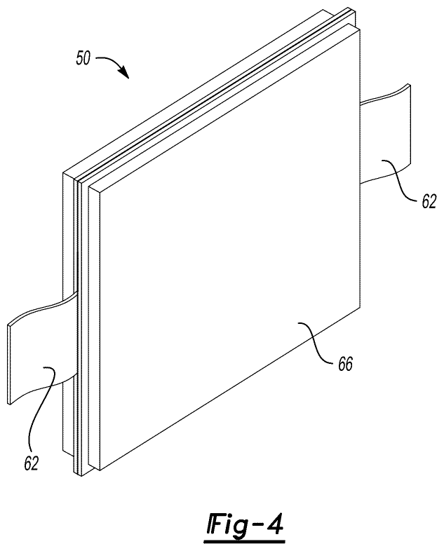

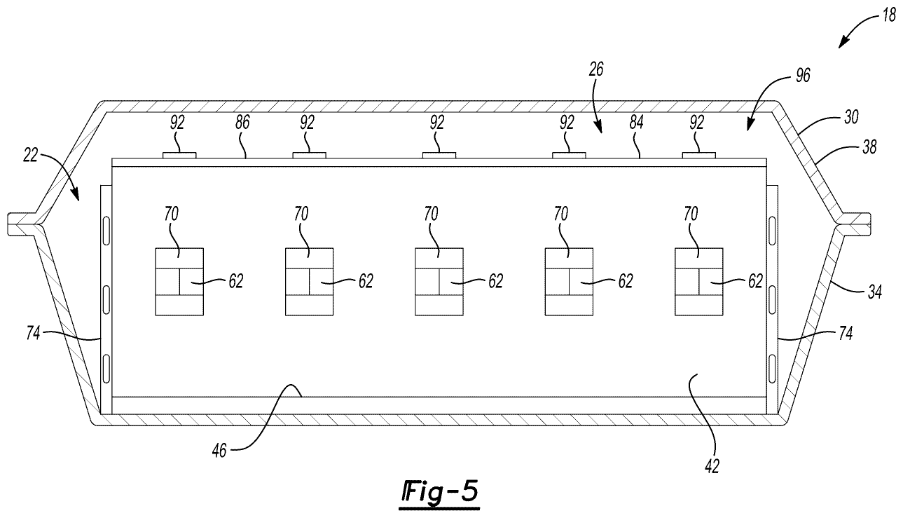

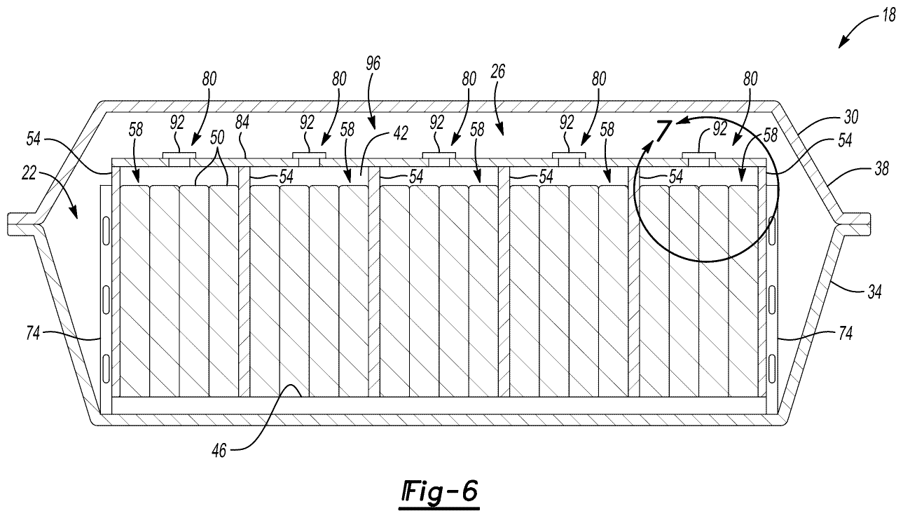

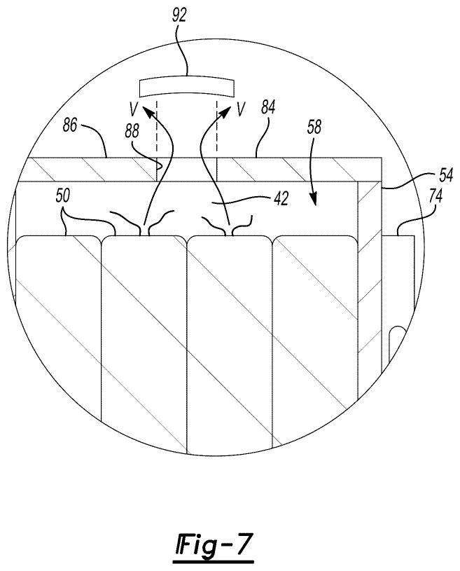

With reference to FIGS. 2-7, the traction battery pack 18 includes a plurality of cell stacks 22 housed within an interior 26 of an enclosure assembly 30, which, in this example, includes an enclosure tray 34 and an enclosure cover 38. The enclosure tray 34 and the enclosure cover 38 cooperate to provide the interior 26 that houses the cell stacks 22.

Within the interior 26, each of the cell stacks 22 is disposed between a pair of busbar frames 42 and positioned upon a thermal exchange plate 46. Although a specific number of the cells stacks 22 are illustrated in the various figures of this disclosure, the traction battery pack 18 could include any number of the cell stacks 22.

Each cell stack 22 includes a plurality of battery cells 50 and a plurality of thermal barriers 54 stacked side-by-side relative to each other along a cell stack axis A. In this example, the battery cells 50 are segregated into groups 58 of at least two battery cells 50 that are separated from each other along the respective cell stack axis A by one of the thermal barriers 54. The battery cells 50 store and supply electrical power for powering various components of the electrified vehicle 10.

In the exemplary embodiment, the battery cells 50 are lithium-ion pouch-style battery cells. However, battery cells having other geometries (cylindrical, prismatic, etc.) and/or chemistries (nickel-metal hydride, lead-acid, etc.) could alternatively be used within the scope of this disclosure. The battery cells 50 each include tab terminals 62 extending from a case 66. In the assembled battery pack 18, the tab terminals 62 of the example battery cells 50 extend through an opening in one of the busbar frames 42 to connect to a busbar 70 that is secured to the one of the busbar frames 42. The busbars 70 can be mounted to the busbar frames 42 with heat stakes, for example. Notably, openings through which the tab terminals 62 extend are sealed.

In the example embodiment, one of two structural members 74 spans across the ends of the cell stacks 22 on a driver side of the battery pack 18. The other of the structural members 74 spans across the ends of the cell stacks 22 on a passenger side of the battery pack 18. The structural members 74 can be extruded beams.

In this example, the cell stacks 22 and the busbar frames 42 extend longitudinally in a cross-vehicle direction of the electrified vehicle 10. The example busbar frames 42 and the cell stacks 22 each span from the structural members 74 on a driver side of the traction battery pack 18 to another of the structural members 74 on a passenger side of the battery pack 18. Among other functions, the busbar frames 42 can be configured to help hold the cell stacks 22 and at least partially delineate the cells stacks 22 from one another within the interior 26.

The thermal barriers 54 and the busbar frames 42 extend vertically upward past the battery cells 50. The groups 58 of battery cells 50 are each received within a compartment 80 in this example. Each of the compartments 80 is established by two of the thermal barriers 54, which provide opposing horizontally facing sides of the respective compartment 80. The other horizontally facing sides are provided by the busbar frames 42. The thermal barriers 54 extend to the respective busbar frames 42 and interface directly with the busbar frames 42. A vertically lower side of each of the compartments 80 can be provided by the thermal exchange plate 46.

The example battery pack 18 includes an intermediate cover assembly 84, which spans over the cell stacks 22 to provide a vertically upper side for the compartments 80 and enclose the groups 58 within respective compartments 80. The compartments 80 are sealed in this example. Each of the groups 58 is completely compartmentalized within one of the compartments 80.

The intermediate cover assembly 84 is spaced a distance from an underside of the enclosure cover 38. The intermediate cover assembly 84 can comprise a sheet 86 of material, such as a sheet of mica or a sheet of Sheet Molding Compound (SMC) having a plurality of apertures 88. Each of the apertures 88 can be covered with, for example, a piece of tape 92, such as a piece of foil tape. Each of the apertures 88 is disposed above one of the compartments 80 in this example. The intermediate cover assembly 84 provides a top side for each of the compartments 80.

From time to time, pressure and thermal energy within at least one of the battery cells 50 in the cell stacks 22 can increase. This can lead to the battery cell 50 discharging a flow of vent byproducts V, which can include gas and debris, from within the battery cell 50. The vent byproducts V can be discharged from the battery cell 50 through designated cell vent within the case 66 of the battery cell 50. The cell vent can be a membrane that yields in response to increased pressure and thermal energy within the battery cell 50. The cell vent can instead be a ruptured area of the battery cell 50. Vent byproducts V discharged one or more of the battery cells 50 are initially communicated from the one or more battery cells 50 into the compartment 80 holding the one or more battery cells 50.

Pressure increases within the compartment 80 due to the vent byproducts V. The increased pressure eventually lifts the tape 92 that covers the aperture 88 and at least partially separates the tape 92 from the sheet 86. With the tape 92 lifted, the vent byproducts V can then move through the aperture 88 into an area 96 between the intermediate cover assembly 84 and the enclosure cover 38. The tape 92 covering the aperture 88 thus provides a compartment vent for the compartment 80.

Each of the compartments 80 of the battery pack 18 has at least one corresponding compartment vent. The compartment vents are one-way vents that open in response to pressure increases within the corresponding compartment. In this example, the compartments 80 each vent exclusively through the associated compartment vent.

The tape 92 covering the apertures 88 remains attached to the sheet 86 to block the vent byproducts V from moving into another compartment 80 holding cells 50 that are not venting. This can help to stop the thermal event associated with the venting from cascading to other cells 50.

Other types of compartment vents could be used in other examples. For example, the compartment vent could be a flap that is cut into the sheet 86 and then secured with a bit of adhesive. A pressure increase within the associated compartment 80 could break the adhesive bond permitting the flap to curl upward so that the vent byproducts V can flow through the aperture 88.

From the area 96, the vent byproducts V can be communicated through an enclosure vent 98 within the enclosure assembly 30. The enclosure vent 98 releases the vent byproducts V to an area outside the enclosure assembly 30 of the traction battery pack 18.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting system, comprising:
a battery pack enclosure providing an interior;
a cell stack within the interior, the cell stack including a plurality of battery cells disposed along a cell stack axis, the plurality of battery cells segregated into a plurality of groups, each of the groups including at least two battery cells;
a plurality of compartments within the interior, each of the groups within the plurality of groups housed within a respective one of the compartments within the plurality of compartments; and
an intermediate cover assembly within the interior, the intermediate cover assembly spanning over the cell stack to enclose the groups within the compartments, the intermediate cover assembly including at least one compartment vent associated with each of the compartments, the compartments each configured to vent through the at least one compartment vent to an area of the interior that is between the intermediate cover and the battery pack enclosure.

2. The battery pack venting system of claim 1, wherein the at least one compartment vent is at least one one-way compartment vent.

3. The battery pack venting system of claim 1, wherein the compartments are each configured to vent exclusively through the at least one compartment vent.

4. The battery pack venting system of claim 1, wherein the plurality of battery cells are a plurality of pouch-style battery cells.

5. The battery pack venting system of claim 1, wherein each of the compartments is configured to vent exclusively through the at least one compartment vent associated with that compartment.

6. The battery pack venting system of claim 1, wherein the intermediate cover assembly is vertically above the plurality of compartments.

7. The battery pack venting system of claim 1, wherein the battery pack enclosure includes an enclosure cover and an enclosure tray, the area between the enclosure cover and the intermediate cover assembly.

8. The battery pack venting system of claim 1, further comprising an enclosure vent that communicates vent byproducts from the interior of the battery pack enclosure.

9. The battery pack venting system of claim 1, wherein opposing sides of the compartments are provided between a first thermal barrier and a second thermal barrier, wherein other opposing sides of the compartments are provided between a first busbar frame and a second busbar frame.

10. The battery pack venting system of claim 9, wherein the first thermal barrier and the second thermal barrier are disposed within the cell stack along the cell stack axis.

11. The battery pack venting system of claim 9, wherein the cell stack is disposed between the first busbar frame and the second busbar frame.

12. The battery pack venting system of claim 11, wherein the plurality of battery cells each include at least one tab terminal that connects to a first busbar mounted to the first busbar frame, a second busbar mounted to a second busbar frame, or both.

13. The battery pack venting system of claim 1, wherein the plurality of compartments are a plurality of sealed compartments.

14. The battery pack venting system of claim 1, wherein the compartments open upward to an underside of the intermediate cover assembly.

15. The battery pack venting system of claim 1, wherein the at least one compartment vent is configured to open in response to a pressure increase within the compartment associated with that at least one compartment vent.

16. The battery pack venting system of claim 1, wherein the at least one compartment vent comprises a foil tape covering an aperture in a sheet of material, the foil tape configured to at least partially separate from the sheet.

17. The battery pack venting system of claim 1, wherein the compartments are each configured to vent vent-byproducts emitted from one or more of the battery cells within one of the groups through the at least one compartment vent to the area of the interior that is between the intermediate cover and the battery pack enclosure.

18. The battery pack venting system of claim 1, wherein the cell stack is disposed on a thermal exchange device within the interior, the thermal exchange device provide a vertically lower side of the at least one compartment.

19. A battery pack venting system, comprising:
a battery pack enclosure providing an interior;
a thermal exchange device;
a cell stack within the interior upon the thermal exchange device, the cell stack including a plurality of battery cells disposed along a cell stack axis, the plurality of battery cells segregated into a plurality of groups separated along the axis by a thermal barrier, each of the groups including at least two battery cells;
a first busbar frame alongside a first side of the cell stack;
a second busbar frame alongside an opposite, second side of the cell stack, the thermal barriers each interfacing directing with the first busbar frame and the second busbar frame such that each of the groups of battery is compartmentalized within one of a plurality of sealed compartments within the interior, the sealed compartments each opening vertically upward, wherein horizontal sides of the sealed compartments are each established by opposing thermal barriers, the first busbar frame, and the second busbar frame, wherein a vertically lower side of the sealed compartment is provided by the thermal exchange device; and
an intermediate cover assembly within the interior, the intermediate cover assembly spanning over the cell stack to cover vertically upper sides of the sealed compartments and to enclose the groups within the sealed compartments, the intermediate cover assembly including at least one compartment vent associated with each of the compartments, the compartments each configured to vent through the at least one compartment vent to an area of the interior that is between the intermediate cover and the battery pack enclosure.
